(19) United States
(12) Patent Application Publication
(10) Pub. No.: US 2026/0042180 A1
(43) Pub. Date: Feb. 12, 2026

(54) EMERGENCY BRAKE ASSEMBLY FOR A MOTOR-DRIVEN TOOL AND METHOD FOR OPERATING AN EMERGENCY BRAKE ASSEMBLY

(71) Applicant: Festool GmbH, Wendlingen (DE)

(72) Inventors: Markus Schmid, Uhingen (DE); Josua Frank, Urbach (DE); Christian Schock, Schorndorf (DE); Kevin Doll, Winderbach (DE)

(73) Assignee: Festool GmbH, Wendlingen (DE)

(21) Appl. No.: 19/100,409

(22) PCT Filed: Aug. 3, 2023
(86) PCT No.: PCT/EP2023/071526

§ 371 Date: Jan. 31, 2025

(30) Foreign Application Priority Data
Aug. 3, 2022 (DE) 10 2022 208 076.9

(51) Int. Cl. B23Q 11/00; B27G 19/04; F16D 63/00; F16D 121/32

(52) U.S. Cl. CPC B23Q 11/0092; B27G 19/04; F16D 63/008; F16D 2121/32

(57) ABSTRACT

An emergency braking assembly for a motor-driven tool has a holding structure, a braking element movably mounted on the holding structure, and a wire-like actuation element, which has a shape-memory alloy. A first end of the actuation element is attached to the holding structure. A second end of the actuation element is drivingly coupled to the braking element. A method operates the emergency braking assembly. The braking element is set in motion by the actuation element and then a motion coupling between actuation element and braking element is cancelled or terminated.

The invention is directed to an emergency brake assembly for a motor-driven tool.

The invention further relates to a method for operating an emergency brake assembly.

Motor-driven tools comprising emergency brake assemblies are known from the prior art. The same is true for emergency brake assemblies. These are used to bring a cutting element, e.g. a saw blade, of the tool to a standstill when, during operation, contact between a user and the cutting element is at risk of occurring or is detected. In this manner, injuries are avoided or the severity thereof is reduced.

In this regard, actuators having actuating elements comprising a shape memory alloy can be used. The function of such actuators is based on a heat-activated lattice conversion of the shape memory alloy, which results in the length of the actuating element changing. An “actuating element” is thus understood to be that element of the actuator by means of which the movement is generated, the movement being required by the actuator for acting upon a system actuated by means of the actuator, in this case the brake system or brake element. Actuating elements which comprise a shape memory alloy are frequently formed as wires which shorten owing to the heat-activated lattice conversion.

Such actuators are preferably used in reversible emergency brake assemblies, i.e. in emergency brake assemblies which can be used multiple times in order to bring the cutting element to a standstill. It is understood that, in the case of reversible emergency brake assemblies, the actuator has to be able to be actuated multiple times with the same high level of reliability.

The object of the invention is thus to further improve emergency brake assemblies, the actuating element of which comprises a shape memory alloy.

The object is achieved by an emergency brake assembly for a motor-driven tool which comprises a holding structure, a brake element movably mounted on the holding structure, in particular a brake cam or a pressure piece, and a wire-shaped actuating element which comprises a shape memory alloy. A first end of the actuating element is fastened to the holding structure. A second end of the actuating element is drivingly coupled to the brake element. In this regard, a “wire-shaped actuating element” is understood to be an actuating element which can be subjected substantially only to tensile loading, i.e. can transfer only tensile forces. Such an actuating element is unstable when subjected to compressive loading. Furthermore, the wire shape implies that the actuating element is very much longer than it is wide. For simplicity, a wire-shaped actuating element comprising a shape memory alloy is frequently also referred to as a shape memory alloy wire, or SMA wire. In the present case, the holding structure is formed e.g. by an actuator housing, i.e. by a housing of the actuator comprising the actuating element, or a brake calliper or a combination thereof. The fact that the second end of the actuating element is drivingly coupled to the brake element means that the brake element can be driven via this coupling, i.e. can be moved at least from a release position, in which the brake element has no braking effect, into a brake position, in which it has a braking effect. The movement of the brake element from the release position into the brake position is preferably caused by a contraction or tightening of the actuating element. The actuating element thus drives the brake element. Such a configuration is simple and robust. In particular, such a configuration is simpler, in structural terms, than designs of emergency brake assemblies in which only a release of movement can be controlled by means of an actuating element comprising a shape memory alloy.

Therefore, in summary, an “emergency brake assembly” is understood to mean a combination of an actuator and a brake element. In the present case, the actuator comprises an actuating element comprising a shape memory alloy. The brake element is e.g. a brake cam or a pressure piece. Such an emergency brake assembly can be part of an emergency brake unit which is configured to brake a cutting element of a motor-driven tool until it comes to a standstill.

With regard to the present invention, a “brake cam” is understood to mean a rotatably mounted brake element which is eccentric at least in sections, and so the brake element can be moved by rotation from a release position, in which the brake element has no braking effect, into a brake position, in which it has a braking effect. In contrast, a pressure piece can be mounted so as to pivotable or movable in a translational manner.

It is understood that the actuating element can comprise, at its ends, insulating elements in order to electrically insulate the actuating element from the holding structure and/or from the brake element.

In one example, the holding structure is produced from a synthetic material. In this case, it is not necessary to provide an insulating element on the first end of the actuating element.

According to one alternative, the second end of the actuating element is fastened to the brake element. In this alternative, the actuating element is thus fastened to the holding structure and also to the brake element. The brake element can thus be driven directly by means of the actuating element. Such a design is particularly simple and robust.

According to another alternative, the second end of the actuating element is coupled to the brake element via at least one intermediate element. The at least one intermediate element is thus arranged between the brake element and the second end of the actuating element such that the brake element can be driven by means of the actuating element and via the intermediate element. Such an intermediate element can be used on the one hand for bridging a geometric distance between the second end of the actuating element and the brake element. On the other hand, the intermediate element can also be used to convert a movement of the second end of the actuating element so that the particular movement drivingly applied to the brake element can be differentiated from the movement of the second end of the actuating element. In this case, the intermediate element can also be understood to be a gear element. An intermediate element thus provides degrees of freedom for adapting the movement of the brake element upon actuation by means of the actuating element.

The at least one intermediate element can comprise a slide which is mounted on the holding structure so as to be movable. The slide is thus driven by means of the actuating element. In turn, the slide directly or indirectly drives the brake element. A slide is a structurally simple and reliable intermediate element, and so the brake element can be driven in a reliable manner.

In one example, the slide is produced from a synthetic material. It is thus not necessary to electrically insulate the second end of the actuating element from the slide. Furthermore, such a slide is comparatively light, yet still robust.

The slide can be mounted on the holding structure so as to be movable in translation via a slide guide. In other words, the slide is guided in a translational manner on the holding structure. Since, in this regard, the holding structure can be designed to be mechanically stable, the slide is also mounted in a reliable and mechanically stable manner. Such a configuration is thus mechanically robust.

It is also possible for the slide to be mounted on the bolding structure so as to be movable via at least one articulation arm. In this alternative also, the slide is mounted in a reliable and mechanically stable manner. In this regard, the articulation arm can be rigid and can be coupled to the holding structure and also to the slide via localised articulations. Alternatively, the articulation arm can be formed as a solid-state articulation arm. In this example, the articulations can be considered as being delocalised since certain sections of the articulation arm provide the function of the articulations, but not specific components or elements.

In a further embodiment, the slide is connected to the holding structure via an elastic bearing element. If the slide moves, the elastic bearing element is elastically deformed. In this alternative also, the slide is mounted on the holding structure in a simple and robust manner. An elastic bearing element also has the advantage that an initial position can be allocated to the slide, in which the elastic bearing element is e.g. not deformed. The bearing element can be configured such that, in the absence of external forces, the slide is returned to this initial position by means of the elastic bearing element.

In one example, the elastic bearing element is formed as a leaf spring element. In another example, the elastic bearing element is formed as a diaphragm spring. In a further example, the elastic bearing element is formed as a helical spring element.

The at least one intermediate element can comprise a pushrod or an actuating pin having a brake element-side end. The brake element-side end of the pushrod or actuating pin lies on the brake element or can be placed on the brake element. In this example, the brake element is thus driven by a pushrod or actuating pin. This is structurally simple and robust. In particular, compressive forces can be applied in a reliable manner to the brake element by means of a pushrod or actuating pin.

In one example, the pushrod or the actuating pin is produced from a synthetic material.

Preferably, the brake element-side end of the pushrod or actuating pin is decoupled or can be decoupled from the brake element via tensile forces. In this example, no tensile force can be exerted on the brake element at least in one operating situation, preferably in all operating situations, by means of the pushrod or actuating pin. Preferably, however, compressive forces can be transferred to the brake element by means of the pushrod or actuating pin. With such a configuration, on the one hand the brake element can be driven by a compressive force in a reliable manner by means of the pushrod or actuating pin. On the other hand, the decoupling, or decoupling capability, by tensile forces also permits mutually independent movements of the pushrod or actuating pin with respect to the brake element, and vice versa. This is particularly advantageous when the brake element is designed to be self-reinforcing, and so it only has to be brought into contact with the cutting element to be braked and a further movement of the brake element results from the contact between the brake element and cutting element, i.e. the actuating element is no longer required for this. In simplified terms, with such a configuration the brake element can be pushed by means of a compressive force. Then, the brake element and the pushrod or actuating pin can move independently of each other. In terms of the actuating element or the actuator, to which the actuating element belongs, the decoupling, or decoupling capability, by tensile forces ensures that the actuator or the actuating element is returned to an initial position which corresponds to a release position of the brake element, wherein the brake element still remains in the brake position. This provides in particular reliable protection for the actuator or the actuating element from loading peaks which result from the engagement of the brake element. Therefore, a high level or reliability and a long service life of the actuator and actuating element are achieved.

In one example, the brake element-side end of the pushrod or actuating pin can be located between the first end of the actuating element and the second end of the actuating element in a direction in parallel with the actuating element. The brake-element side end of the pushrod or actuating pin is thus located next to the actuating element. In this manner, a compact design for the emergency brake assembly is produced because the brake element-side end of the pushrod or actuating pin does not enlarge the emergency brake assembly in a dimension, corresponding to a direction of the actuating element, starting from the actuating element. In simplified terms, the brake element-side end of the pushrod or actuating pin does not protrude beyond a length of the actuating element.

According to one variant, the pushrod or actuating pin has a central axis and the central axis extends in parallel with the actuating element. In this regard, the central axis of the actuating pin can also be referred to as “pin axis” and the central axis of the pushrod can be referred to as “pushrod axis”. This has the result that forces acting within the actuating element and forces acting within the pushrod or actuating pin extend in parallel. This is advantageous from a mechanical point of view.

The central axis of the pushrod or actuating pin can be spaced apart from the actuating element. The central axes are thus preferably arranged in a parallel-offset manner. A design is produced which is advantageous in terms of forces and is also compact.

The pushrod or actuating pin can be guided on the holding structure. The pushrod or actuating pin is thus guided in a reliable and robust manner. In particular, guidance occurs longitudinally, i.e. along the central axis of the pushrod or actuating pin. At the same time, guidance can be configured to prevent the pushrod or actuating pin from tilting. In this regard, the actuating pin or pushrod is preferably guided in proximity to its brake element-side end, e.g. in the half of the actuating pin or pushrod facing the brake element. In this manner, by means of the guidance on the holding structure, a particularly precise position and/or movement of the brake element-side end can be achieved and so the brake element can be actuated with a high level of precision.

In one example, the pushrod or actuating pin is guided in a guide channel which is formed on the holding structure. A through-going hole or a through-going bore is an alternative to the guide channel. Such a guidance is particularly simple from a structural and manufacturing point of view.

Advantageously, the brake element-side end of the actuating pin or pushrod is rounded. Therefore, even in the case of the tolerance-encumbered relative positions between the actuating pin or pushrod and brake element, forces can be transferred from the actuating pin or pushrod into the brake element with a high level of reliability. In particular, force peaks resulting from the tolerance-encumbered relative positions are avoided by the rounded ends. Therefore, such an emergency brake assembly operates on the whole in a particularly robust manner.

In one example, the pushrod or actuating pin has a circular-cylindrical basic shape. Such actuating pins or pushrods are particularly simple from a manufacturing point of view.

An actuating element-side end of the pushrod or actuating pin can be coupled to the slide. In this example, a slide and a pushrod or actuating pin are thus provided as intermediate elements. For example, the coupling between the slide and the actuating pin or pushrod is rigid, i.e. it can transfer compressive and tensile forces along a central axis of the pushrod or actuating pin. Furthermore, such a rigid coupling can transfer transverse forces. Alternatively, the coupling can also be configured such that only compressive forces can be transferred. In all variants, a reliable coupling is established between the slide and actuating pin or pushrod, i.e. a reliable driving coupling between the actuating element and brake element.

In one exemplified embodiment, the actuating element is guided by means of a guide element. In this manner, bulging of the actuating element is prevented at least locally. Therefore, the actuating element is protected from undesired damage.

For example, the guide element is formed as a portion of the holding structure, in particular as a portion of the actuator housing and/or of the brake calliper. A compact design is produced.

The emergency brake assembly can also comprise a spring element, by means of which the actuating element is directly or indirectly spring-loaded in a direction corresponding to tensile loading of the actuating element. The actuating element is thus tensioned by means of the spring element. A shortening of the actuating element can thus be used directly and precisely to drive the brake element. In particular, undesired clearance within the driving coupling between the actuating element and the brake element is prevented. Furthermore, such spring loading ensures that the actuating element is reliably and precisely returned to an unactuated state after an actuation, It is understood that in a case in which a slide or a pushrod or actuating pin is provided, the spring element can be supported on the slide, pushrod or actuating pin. Alternatively or in addition, the spring element is supported on the holding structure and/or on the guide element.

The spring element can surround the pushrod or the actuating pin around the circumference at least in sections. Alternatively or in addition, the spring element and the pushrod or the actuating pin can be arranged coaxially. A compact design for the emergency brake assembly is thus produced. Furthermore, tilting moments which may result from the spring loading are reduced.

In one variant, the spring element surrounds the actuating element around the circumference at least in sections. A compact design for the emergency brake assembly is thus also produced. Furthermore, in this manner a purely axial spring loading of the actuating element is promoted.

In one example, the holding structure is formed by an actuator housing and/or a brake calliper. The actuating element is thus fastened to the actuator housing and/or to the brake calliper. Such a design is simple and can be compact.

In one example in which the holding structure is formed by the actuator housing and not by the brake calliper, the actuator, which includes the actuator housing and the actuating element, can be releasably attached to the brake calliper. A common tool may be required for this purpose. As a result, the actuator can be detached from the brake calliper and replaced as required, e.g. in the event of a defect. Such a configuration is thus repair-friendly,

In addition, a control unit for the actuating element can be integrated into the actuator housing at least in sections. This also produces a space-saving design for the emergency brake assembly.

According to one embodiment, a first sleeve is provided on the first end of the actuating element and the first end of the actuating element is fastened to the holding structure via the first sleeve. The actuating clement can be fastened to the holding structure by means of the sleeve in a simple and reliable manner. In addition, the sleeve can comprise an electrically insulating material as required, and so the sleeve is or comprises an electrically insulating element.

According to a further embodiment, a second sleeve is provided on the second end of the actuating element and the second end of the actuating element is drivingly coupled to the brake element via the second sleeve. The actuating element can be fastened to the brake element or an intermediate element by means of the sleeve in a simple and reliable manner. In addition, the sleeve can comprise an electrically insulating material as required, and so the sleeve is or comprises an electrically insulating element.

The first sleeve and/or the second sleeve can be injection moulded onto the actuating element. In this manner, the sleeves can be produced and attached to the actuating element in a simple and cost-effective manner. Owing to the injection moulding process, there is no need to perform further assembly steps for attaching the first sleeve and/or the second sleeve.

Preferably, a length of the actuating element is smaller than a dimension of the emergency brake assembly in a direction in parallel with the length of the actuating element. Alternatively or in addition, a length of the actuating element lies completely within a dimension of the emergency brake assembly measured in parallel with the length of the actuating element. The length of the actuating element thus does not determine a maximum outer dimension of the emergency brake assembly. Therefore, by using the actuating element, a comparatively compact emergency brake assembly can be created.

The actuating element and/or a portion of the holding structure can mechanically shield a drive coupling portion of the brake element. In this regard, a “drive coupling portion” is understood to mean a portion of the brake element to which the second end of the actuating element is fastened or at which an intermediate element, e.g. a pushrod or actuating pin, contacts the brake element. If the emergency brake assembly is viewed from the outside, the drive coupling portion is thus located further within the emergency brake assembly than the actuating element and/or the portion of the holding structure. As a result, protection against a human hand being engaged in the drive coupling portion and protection against the ingress of foreign bodies are provided.

In a further example, at least one portion of an actuator housing can mechanically shield the drive coupling portion of the brake element. If the emergency brake assembly is again viewed from the outside, the drive coupling portion is thus located further within the emergency brake assembly than the actuator housing. As a result, protection against a human hand being engaged in the drive coupling portion and protection against the ingress of foreign bodies are again provided.

The object is also achieved by a method for operating an emergency brake assembly having a movably mounted brake element for braking a cutting element of a motor-driven tool. The emergency brake assembly also comprises a wire-shaped actuating element comprising a shape memory alloy. The actuating element is drivingly coupled to the brake element. The method comprises:
moving the brake element by means of the actuating element, and
subsequently cancelling or terminating a movement coupling between the actuating element and brake element.

In particular, by means of this method the brake element is moved such that it contacts the cutting element to be braked. In this case, the brake element can exert the desired brake effect. In a further preferred manner, the brake element cooperates with the cutting element in a self-reinforcing manner. This means that the brake effect produced upon first contact between the brake element and the cutting element, e.g. in the form of a braking torque, is further increased owing to an interaction between the brake element and the cutting element. This is for example possible when the brake element is designed as a brake cam or a pressure piece mounted in an articulated manner. With such a method, a comparatively compact and comparatively inefficient actuating element may be sufficient to achieve a comparatively strong brake effect in a reliable manner. Cancelling or terminating the movement coupling prevents undesired mechanical influences from the brake element from retroacting in the actuating element.

The concept forming the basis of the method in accordance with the invention can be summarised in simplified terms as follows: the brake element is bumped or pushed by means of the actuating element merely in the direction of the cutting element until the brake element comes into contact with the cutting element. Then, the actuating element is decoupled from the brake element so that the brake element can move further in the direction of a brake position independently of the actuating element. In a position in which the cutting element is just braked by means of the brake element or is already braked until it comes to a standstill, an optionally provided intermediate element, e.g. the pushrod or actuating pin, is separated, i.e. spaced apart, from the brake element. In one variant in which the actuating element is fastened directly to the brake element, decoupling is achieved by virtue of the fact that the actuating element, in a position in which the cutting element is just braked by means of the brake element or is already braked until it comes to a standstill, assumes a state in which it can no longer influence the movement of the brake element, or can do so only to a minor extent. For example, the actuating element in this regard is loose. The fact that the actuating element is decoupled from the brake element also ensures that an operational displacement of the drive coupling portion of the brake element, i.e. a movement interval of the drive coupling portion which it travels through upon actuation, can be greater than an operational displacement of the actuating element. An actuating element having a comparatively small operational displacement can thus be combined with a brake element which has a comparatively large operational displacement.

It is understood that the method in accordance with the invention can be carried out by means of the emergency brake assembly in accordance with the invention.

According to one variant, the method further includes returning the actuating element to an initial position, wherein the returning occurs independently of the brake element. Returning of the actuating element can thus already occur whilst the brake element is still in a brake position. The brake element can then likewise be returned some time thereafter. In this manner, it is ensured that the actuating element is ready for use again as soon as possible after its actuation.

The object is also achieved by a method for operating an actuator of an emergency brake unit for a motor-driven tool. The actuator comprises an actuating element comprising a shape memory alloy. The actuating element is coupled to at least one electrical energy storage unit via an electrical switching element, and so the actuating element, by actuation of the switching element, can be selectively supplied with electrical energy stored in the energy storage unit. The method comprises:
detecting or obtaining an ambient parameter and/or a first operating parameter of the actuator and/or a second operating parameter of the tool equipped with the actuator, and
operating the actuator in dependence upon the detected or obtained ambient parameter and/or the detected or obtained first operating parameter and/or the detected or obtained second operating parameter.

In this regard, the designations of first operating parameter and second operating parameter are used merely to be able to better distinguish between an operating parameter of the actuator and an operating parameter of the tool equipped with the actuator. A number of operating parameters is not implied. The method in accordance with the invention thus considers an ambient parameter, which describes the environment in which the actuator of the emergency brake unit is operated and/or a first operating parameter characterising an operating state of the actuator and/or a second operating parameter characterising an operating state of the tool equipped with the actuator. Since the actuator is operated in dependence upon the ambient parameter and/or upon the first operating parameter and/or upon the second operating parameter, it is ensured that the actuator can always be operated with a constant operating characteristic despite a varying ambient parameter and/or first operating parameter and/or second parameter. The actuator thus functions reliably, independently of the ambient parameter and/or the first operating parameter and/or the second operating parameter. Of course, this even applies in the case of the actuator being actuated multiple times. It is understood that operating the actuator is only possible in dependence upon a parameter which has previously also been detected or obtained. In detail, it can thus be ensured that the actuating element is supplied with current upon each actuation, the current being of sufficient magnitude to effect safe and reliable actuation of the actuator. In particular, sufficiently rapid actuation of the actuator is achieved. At the same time, however, the current can be selected to be so low that excessive ageing of or even damage to the actuator is avoided. A low amount of current implies a low thermal loading of the shape memory alloy. This results in comparatively slow ageing. An actuator operated by means of the method in accordance with the invention thus has a high level of reliability and a long service life.

The tool can be a hand-held tool-which can also be referred to as a hand tool-a semi-stationary tool or a stationary tool.

In a preferred embodiment, the tool is a saw. This can be a hand saw, a semi-stationary saw or a stationary saw. An example of a hand saw is a circular hand saw. An example of a semi-stationary saw is a mobile circular bench saw. An example of a stationary saw is a panel saw.

The electrical energy storage unit can be an electrical capacitor or a battery. It is insignificant whether the electrical energy storage unit, i.e. the capacitor or the battery, is designed in structural terms as a component of the actuator or as a component of the tool. It is only important that the electrical energy storage unit is electrically coupled to the actuating element.

The emergency brake unit is in particular an emergency brake unit which can be triggered multiple times.

The ambient parameter can comprise a detected or obtained ambient temperature. The actuator can thus always be operated with a high level of reliability independently of the ambient temperature. At the same time, undesired ageing phenomena can be avoided. This is due to the fact that, in dependence upon the ambient temperature, a current level for actuating the actuating element can be selected which is sufficient for reliably actuating the actuator but also does not cause unnecessary thermal loading. Specifically, in the case of a comparatively high ambient temperature, a comparatively low current level is selected. In the case of a comparatively low ambient temperature, a comparatively high current level is selected.

The first operating parameter can comprise a temperature of the actuating element. As already mentioned, the function of the actuating element is based on a heat-activated lattice conversion of the shape memory alloy. Therefore, a reliable function of the actuating element can be ensured and at the same time excessive thermal loading, which results in undesired ageing effects on the shape memory alloy, are avoided.

Alternatively or in addition, the second operating parameter can comprise a rotational speed of the tool and/or a power consumption of the tool. Therefore, triggering of the emergency brake system by means of the actuator may only be permissible when the second operating parameter exceeds a defined rotational speed and/or a defined power consumption.

According to one embodiment, operating the actuator in dependence upon the detected or obtained ambient parameter and/or the detected or obtained first operating parameter and/or the detected or obtained second operating parameter comprises adjusting an actuating current parameter for the actuating element in dependence upon the detected or obtained ambient parameter and/or the detected or obtained first operating parameter and/or the detected or obtained second operating parameter. It is also understood that the actuator may only be operated in dependence upon a parameter which has previously been detected or obtained. In this regard, the actuating current parameter is understood to be a variable characterising the current used for actuating the actuating element. The actuating current parameter describes e.g. a maximum actuating current or a duration of the current feed. It is emphasised that, owing to the comparatively short actuating time of only a few milliseconds, the actuating current parameter is adjusted some time before the actuation. The actuating current parameter has a direct influence on the ageing of the actuating element.

In one variant, the actuating current parameter is adjusted in that an electrical resistance applied between the energy storage unit and the actuating element is adjusted in dependence upon the detected or obtained ambient parameter and/or the detected or obtained first operating parameter and/or the detected or obtained second operating parameter. By means of the electrical resistance, a course of the actuating current acting on the actuating element is adjusted.

In another variant, the actuating current parameter is adjusted in that a capacitance of the energy storage unit is adjusted in dependence upon the detected or obtained ambient parameter and/or the detected or obtained first operating parameter and/or the detected or obtained second operating parameter. An adjustment is also made as to which charge amount can be stored on the energy storage unit and can be fed into the actuating element via the switching element. It is understood that a comparatively high charge amount results in a comparatively high and/or a comparatively long-lasting actuating current.

In this regard, an energy storage unit having an adjustable capacitance can be created, in that an energy storage unit is selected, the capacitance of which can be adjusted per se. Alternatively, an energy storage unit can be selected which comprises two or more energy storage elements, wherein each of the energy storage elements can be selectively switched on and off.

It is also possible that the actuating current parameter is adjusted in that a storage voltage of the energy storage unit is adjusted in dependence upon the detected or obtained ambient parameter and/or the detected or obtained first operating parameter and/or the detected or obtained second operating parameter. Via the storage voltage an adjustment can also be made as to which charge amount can be stored on the energy storage unit and can be fed into the actuating element via the switching element. It is understood that a comparatively high charge amount results in a comparatively high and/or a comparatively long-lasting actuating current.

Alternatively or in addition, the actuating current parameter can be adjusted in that an actuating time of the switching element is adjusted in dependence upon the detected or obtained ambient parameter and/or the detected or obtained first operating parameter and/or the detected or obtained second operating parameter. A duration of the current feed is thus adjusted in dependence upon the ambient parameter and/or the first operating parameter and/or the second operating parameter.

According to one exemplified embodiment, the actuating element is temperature-controlled. This means that a temperature of the actuating element is adjusted to a particular value or to a particular value range. For the case where controlling the temperature brings the actuating element to a temperature which is above an ambient temperature, preheating can also be contemplated. This can alternatively be referred to as priming. Controlling the temperature of the actuating element ensures that it can be actuated independently of an ambient temperature. In particular, a constant energy is required for actuation independently of the ambient temperature. In other words, a first operating parameter of the actuating element, which describes the temperature of the actuating element, is constant or kept in a predetermined range. This ensures that on the one hand the actuating element functions in a reliable manner and on the other hand ageing processes are prevented.

The temperature of the actuating element can be controlled in two ways. Either heat is supplied to the actuating element from the outside or an electrical current is fed through the actuating element which results in it being heated. In both alternatives, a temperature of the actuating element can be adjusted precisely. Of course, these temperature-control methods can also be combined.

The temperature of the actuating element can be controlled to a temperature above a current ambient temperature and below a switching temperature, i.e. a temperature at which the lattice conversion begins, of the actuating element. For example, the temperature of the actuating element can be controlled to a temperature corresponding to 50% to 90% of the switching temperature of the actuating element. In this manner, it is ensured that the actuating element can be actuated starting from the temperature-controlled state by means of a comparatively low actuating current and/or a comparatively low actuating charge amount. Since, owing to the temperature control, a minimum temperature of the SMA wire is ensured, an actuating current can be selected which is less than a required actuating current at a lower temperature of the actuating element. This also helps to protect the actuating element against undesired ageing effects by excessive currents and/or to ensure maximum performance over time independently of the ambient temperature.

In this regard, it is possible on the one hand to control the temperature of the actuating element to a particular temperature. On the other hand, a temperature resistance characteristic curve of the shape memory alloy can be used to control the temperature of the actuating element to a temperature corresponding to a maximum electrical resistance. The first case is referred to as temperature-dependent preheating or temperature control. The second case is referred to as resistance-dependent preheating or temperature control.

In one variant, the tool is deactivated until a desired minimum temperature of the actuating element is achieved. In this manner, it is ensured that the emergency brake unit is ready for use before it is possible to work with the tool.

Alternatively, a warning signal or a warning indication can by output by means of the tool for as long as a desired minimum temperature of the actuating element has not yet been reached. In this manner, a user, being aware of whether the emergency brake unit is ready for use, can make a decision as to whether or not he/she wishes to work with the tool.

In a further alternative, in a case in which a desired minimum temperature of the actuating element has not yet been reached, a sufficiently high actuating current and/or a sufficiently high actuating charge amount is adjusted. As soon as the desired minimum temperature is reached, the actuating current and/or the actuating charge amount is reduced.

The object is also achieved by means of a control circuit for an actuator of an emergency brake unit for a motor-driven tool. The actuator comprises an actuating element comprising a shape memory alloy. The control circuit comprises at least one electrical energy storage unit and an electrical switching element. The electrical energy storage unit and the electrical switching element can be electrically coupled to the actuating element, and so the actuating element, by actuation of the switching element, can be selectively supplied with electrical energy stored in the energy storage unit. The energy storage unit has an adjustable capacitance and/or the control circuit has an adjustable resistance and/or the control circuit has an adjustable voltage converter electrically coupled to the energy storage unit so that a storage voltage of the energy storage unit can be adjusted, and/or the actuating time of the electrical switching element can be adjusted. All of these alternatives can be used to adjust an actuating current parameter. This can occur in dependence upon the ambient parameter and/or the first operating parameter and/or the second operating parameter. As already mentioned, the actuating current parameter describes e.g. a maximum actuating current or a duration of the current feed. By means of such a control circuit, an actuating element comprising a shape memory alloy can thus be controlled in such a manner that on the one hand rapid and reliable actuation is effected and on the other hand undesired ageing effects are prevented.

The adjustable voltage converter is e.g. a so-called step-up converter.

The control circuit can also comprise a temperature-control device which can be coupled to the actuating element in order to control the temperature of the actuating element. By means of such a temperature-control device, the effects and advantages already mentioned in relation to the method step of temperature-control can be achieved. Reference is made to the statements above.

The temperature-control device can comprise a measuring instrument for measuring a temperature of the actuating element and/or for measuring an electrical resistance of the actuating element. The electrical resistance can be measured by a combined measurement of a current flowing through the actuating element and a voltage dropping across the actuating element. Therefore, the temperature of the actuating element can be controlled by means of a closed loop system. As a result, particularly precise temperature control is permitted.

In a case in which a temperature resistance characteristic curve of the actuating element is known, a temperature and a resistance can be converted into each other.

Moreover, the object is achieved by an actuator unit comprising a control circuit in accordance with the invention and an actuator. The actuator comprises an actuating element comprising a shape memory alloy. The actuator is electrically coupled to the control circuit. The actuating element can thus be supplied with current in a targeted manner, the current being of sufficient magnitude to effect safe and reliable actuation of the actuator. In particular, sufficiently rapid actuation of the actuator is achieved. At the same time, however, the current is so low that excessive ageing of or even damage to the actuator is avoided. A low amount of current implies a low thermal loading of the shape memory alloy. This results in comparatively slow ageing. Such an actuator unit consequently has a high level of reliability and a long service life. In particular, the actuator unit can be actuated multiple times.

The actuating element is preferably in the form of a wire. Owing to the fact that the actuating element comprises a shape memory alloy, this wire shortens when it is heated to a temperature above a triggering threshold. Such a triggering threshold can also be referred to as switching temperature. If the wire is then cooled to its ambient temperature, the shortening is reversed.

According to one variant, the actuating element is thermally insulated from its surroundings. Since the actuating element comprises the shape memory alloy, the shape memory alloy is also thermally insulated from its surroundings. Therefore, temperature fluctuations of the shape memory alloy can be damped. This slows undesired ageing of the shape memory alloy.

The object is also achieved by an emergency brake unit for a motor-driven tool comprising an actuator unit in accordance with the invention. Such an emergency brake unit has a high level of reliability and a long service life. In particular, the emergency brake unit can be used multiple times, wherein the reliability can be maintained at a high level over the entire service life.

For the remainder, the effects and advantages mentioned for any one of the method in accordance with the invention, control circuit in accordance with the invention, actuator unit in accordance with the invention and emergency brake unit in accordance with the invention are also applicable in equal fashion to all others of the method in accordance with the invention, control circuit in accordance with the invention, actuator unit in accordance with the invention and emergency brake unit in accordance with the invention.

The invention will be explained hereinafter with the aid of various exemplified embodiments which are illustrated in the attached drawings. In the figures:

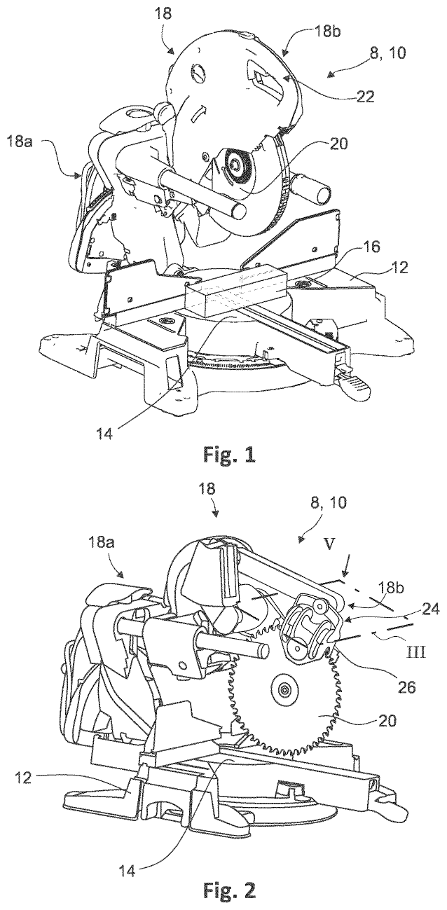

FIG. 1 shows a sawing device having an emergency brake unit which is equipped with an actuator unit which comprises a control circuit in accordance with the invention and an actuator which can be operated by means of a method,

FIG. 2 shows the sawing device of FIG. 1, wherein a housing part and a protective cover are left out,

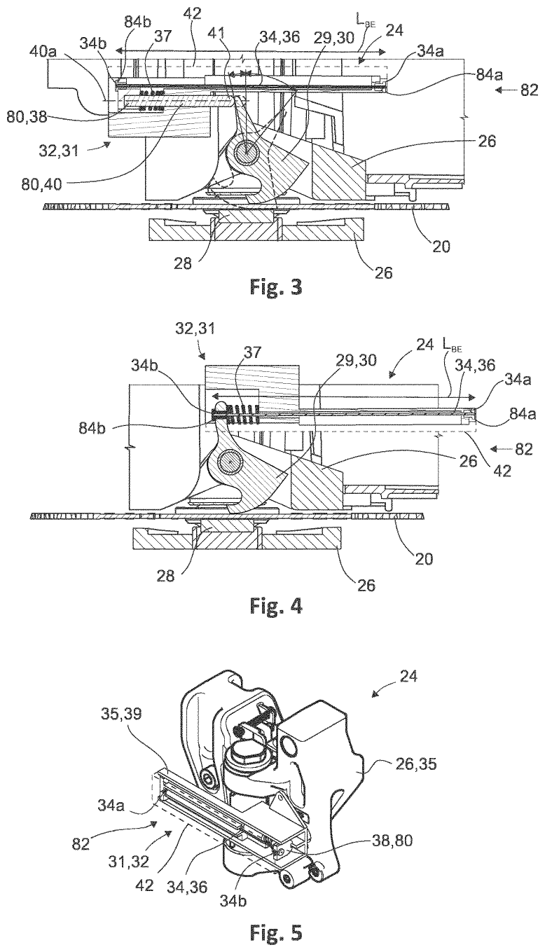

FIG. 3 shows a cross-sectional view of the sawing device of FIG. 2 along the plane III,

FIG. 4 shows a view corresponding to FIG. 3 of an alternative embodiment of the emergency brake unit,

FIG. 5 shows a view along the direction V in FIG. 2 of the emergency brake unit in an isolated illustration,

FIG. 6 shows a view corresponding to FIG. 3 of a further alternative embodiment of the emergency brake unit,

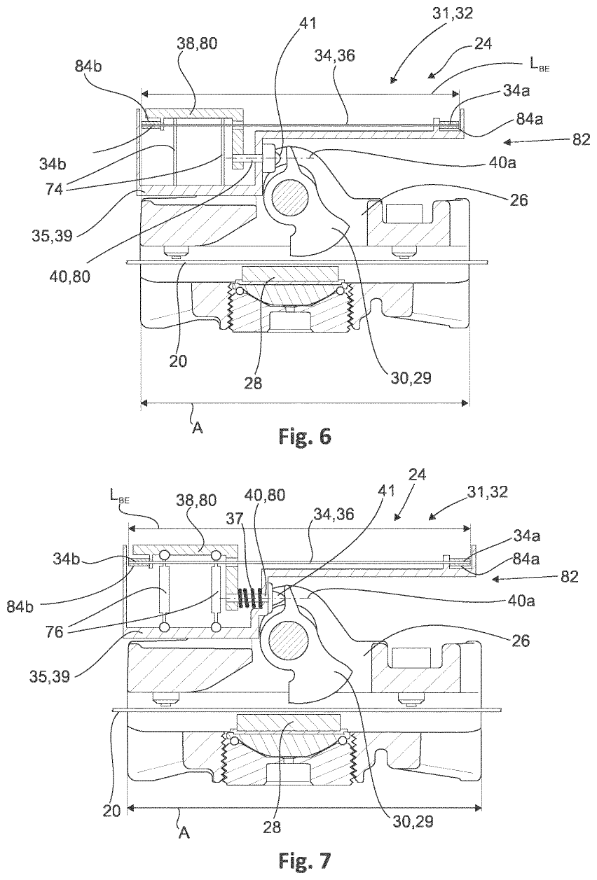

FIG. 7 shows a view corresponding to FIG. 3 of another alternative embodiment of the emergency brake unit,

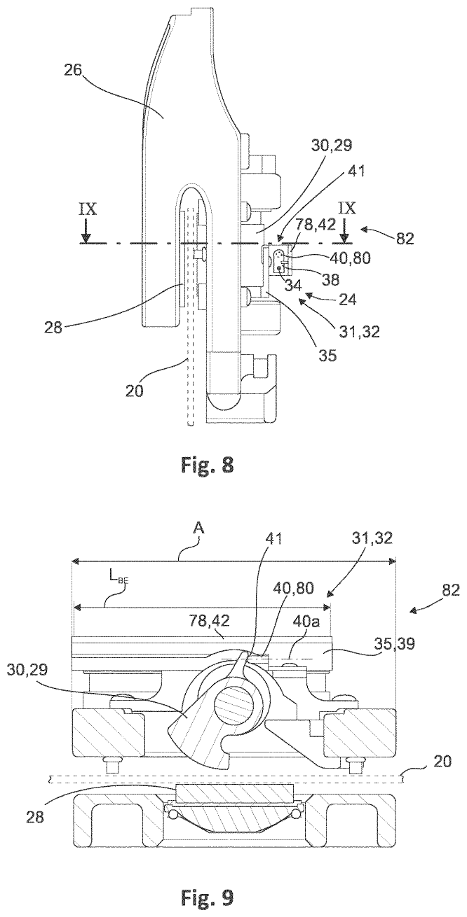

FIG. 8 shows a view of an emergency brake unit according to another embodiment,

FIG. 9 shows a cross-sectional view of the emergency brake unit of FIG. 8 along the plane IX-IX,

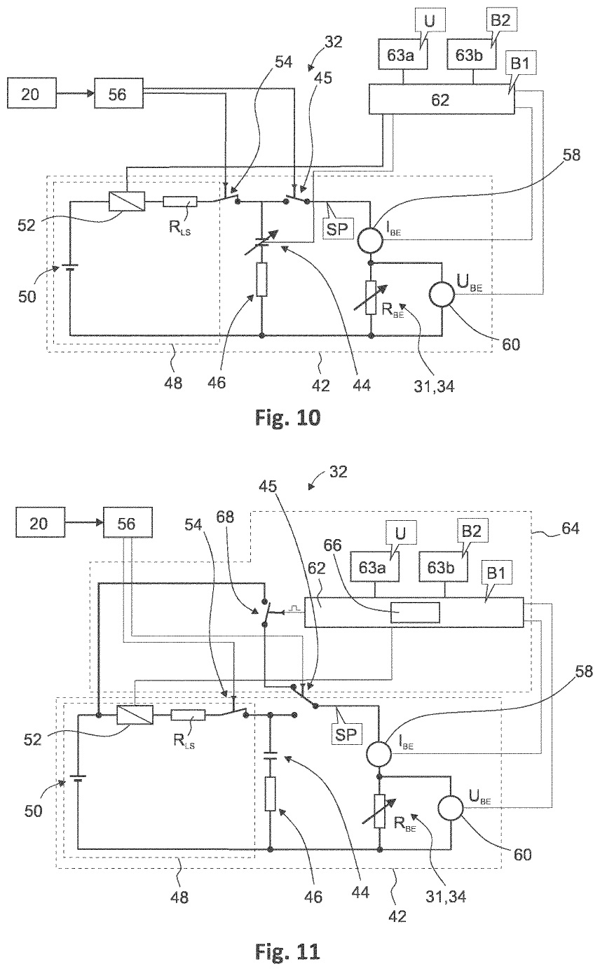

FIG. 10 shows the actuator unit in accordance with the invention from FIGS. 1 and 2 in the form of an electrical circuit diagram, wherein the actuator is represented by the actuating element in the form of a wire consisting of a shape memory alloy,

FIG. 11 shows an alternative embodiment of the actuator unit in accordance with the invention in an illustration corresponding to FIG. 6,

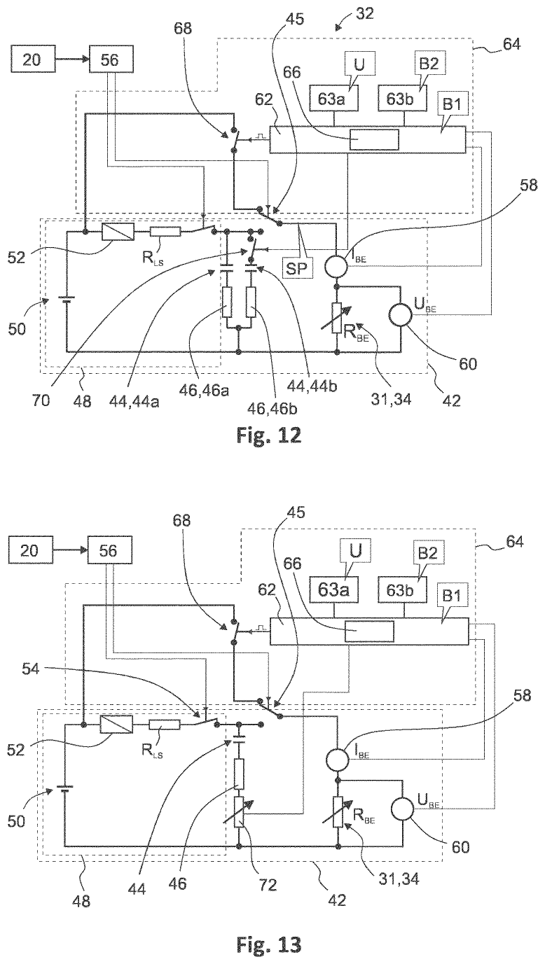

FIG. 12 shows a further alternative embodiment of the actuator unit in accordance with the invention in an illustration as per FIGS. 6 and 7, and

FIG. 13 shows another alternative embodiment of the actuator unit in accordance with the invention in an illustration as per FIGS. 6 to 8.

FIGS. 1 and 2 shows a motor-driven tool 8 which in the illustrated example is a sawing device 10, more precisely a mitre saw.

The sawing device 10 comprises a base part 12 which comprises a support surface 14 for a workpiece 16. The workpiece 16 is to be understood as being an example.

Furthermore, the sawing device 10 comprises a pivot device 18 which is mounted on the base part 12 in an articulated manner on a first portion 18a. A disc-shaped saw blade 20 is mounted on a second portion 18b which is spaced apart from the first portion 18a. Furthermore, a handle 22 is provided on the second portion 18b.

By means of the handle 22, a user of the sawing device 10 can thus bring the rotating saw blade 20 into interaction with the workpiece 16 mounted on the support surface 14, thereby sawing the workpiece.

The sawing device 10, i.e. the motor-driven tool 8, is also equipped with an emergency brake unit 24.

The emergency brake unit 24 is designed to brake the saw blade 20 until it comes to a standstill when, in a state in which the saw blade 20 is rotating, it is detected that a user comes into contact with the saw blade 20 or there is a risk of such contact.

In this regard, the saw blade 20 is used as a capacitive sensor element, i.e. an electric capacitance of the saw blade 20 is continuously detected. For the case that the electric capacitance is outside a predetermined normal range, contact is detected.

FIGS. 3 to 9 illustrate different embodiments of the emergency brake unit 24.

In this regard, the emergency brake unit 24 comprises a brake calliper 26 which engages over an edge of the saw blade 20, and so a pressure element 28 provided on the brake calliper 26 is arranged on a first axial side of the saw blade 20 and a brake cam 30 rotatably mounted on the brake calliper 26 is arranged on a second axial side of the saw blade 20.

In a more general manner, the brake cam 30 can also be referred to as brake element 29.

The brake cam 30 is coupled to an actuator unit 32 which includes an actuator 31 and a control circuit, which will be explained hereinafter and is electrically coupled to the actuator. By means of the actuator 31, the brake cam 30 can be selectively rotated such that it presses the saw blade 20 against the pressure element 28 and as a result brakes the saw blade until it comes to a standstill.

In the variant of FIG. 3, the actuator 31 comprises an actuating element 34 comprising a shape memory alloy 36. Specifically, the actuating element 34 is formed as a wire which is produced from the shape memory alloy 36.

The actuating element 34 is fastened at a first end 34a to a fastening element receiver. The fastening element receiver can be part of the brake calliper 26 or part of a holding structure 35 fixed to the brake calliper 26. The holding structure 35 can be formed by an actuator housing 39 which is fastened to the brake calliper 26.

Of course, the holding structure 35 can also be formed by the brake calliper 26 or by the brake calliper 26 and the actuator housing 39 together.

The other end 34b of the actuating element 34 is fastened to a slide 38 which is mounted so as to be displaceable in translation relative to the brake calliper 26. The slide 38 is spring-loaded in a direction corresponding to a tensile loading of the actuating element 34. Furthermore, the slide 38 is, or can be, coupled to the brake cam 30 via an actuating pin 40.

If the actuating element 34 is powered with an electric current of sufficient magnitude, heat-induced lattice conversion of the shape memory alloy 36 takes place which results in the actuating element 34 shortening. This results in displacement of the slide 38 and of the actuating pin 40 towards the right in FIG. 3. As a result, the brake cam 30 is brought into engagement with the saw blade 20 and brakes it until it comes to a standstill.

For improved understanding, in FIG. 3 the actuating pin 40 and the brake cam 30 are illustrated with solid lines in an unactuated state. The unactuated state relates to a state in which the actuating element 34 is not yet powered with an electric current of sufficient magnitude. Accordingly, the brake cam 30 does not interact with the saw blade 20. Furthermore, the actuating pin 40 and the brake cam 30 are illustrated with dashed lines in an actuated state. In this state, the actuating element 34 has been powered with an electric current of sufficient magnitude and so in FIG. 3 the actuating pin 40 has been displaced to the right and the brake cam 30 has rotated in the clockwise-direction. The saw blade 20 is thus clamped between the brake cam 30 and the pressure element 28. In the actuated state, the actuating pin 40 and the brake cam 30 are separated, i.e. spaced apart, from each other.

FIG. 4 shows an alternative embodiment of the actuator unit 32. In this embodiment, the first end 34a of the actuating element 34 is fixed relative to the brake calliper 26 as usual.

In contrast to the variant of FIG. 3, the second end 34b is fastened to the brake cam 30. The brake cam 30 is spring-loaded. The loading direction again corresponds to a tensile loading direction for the actuating element 34.

If in the variant in FIG. 4 the actuating element 34 is powered with an electric current of sufficient magnitude, heat-induced lattice conversion of the shape memory alloy 36 takes place which results in the actuating element 34 shortening. This results in rotation of the brake cam 30 and so this is brought into engagement with the saw blade 20 and brakes it until it comes to a standstill. In FIG. 4, the brake cam 30 rotates in the clockwise-direction upon triggering of the emergency brake unit 24.

The actuator 31 for operating the emergency brake unit 24 thus comprises the actuating element 34 comprising a shape memory alloy 36, the holding structure 35 and a spring element 37 arranged on the holding structure 35, wherein the spring element 37 biases the second end 34b of the actuating element 34 relative to the first end 34a of the actuating element 34 and/or defines a preferred position of the actuating pin 40—preferably extending along a pin axis 40a—relative to the holding structure 35.

The actuating element 34 always extends along a shortening direction which extends from the first end 34a of the actuating element 34 to the second end 34b of the actuating element 34.

In the variant shown in FIG. 3, the actuating pin 40 is mounted so as to be displaceable in translation along the pin axis 40a relative to the holding structure. The actuating pin 40 is mounted in a through-going hole in the holding structure 35.

The actuating element 34 is fastened at its first end 34a to the fastening element receiver of the holding structure 35 and is, or can be, coupled at its second end 34b to the brake cam 30.

In the variant shown in FIG. 3, the second end 34b is, or can be, coupled to the brake cam 30 via the actuating pin 40.

The pin axis 40a and the shortening direction of the actuating element 34 preferably extend in parallel.

Alternatively or in addition, the actuating pin 40 and the second end 34b of the actuating element 34 can be displaced in parallel with each other in the same direction by triggering the emergency brake unit 24.

Preferably, the movement is a linear movement.

In the variant shown in FIG. 3, the actuating pin 40 and the second end 34b of the actuating element 34 are coupled by means of the slide 38 and so the actuating pin 40 can be brought into engagement with the brake cam 30 via the slide 38.

The slide 38 is engaged with a guide contour arranged on the holding structure 35. In this manner, rotation of the slide 38 relative to the holding structure can be avoided. Alternatively, provision can also be made that the actuating pin 40 is engaged with a guide contour arranged on the holding structure.

In the variant shown in FIG. 4, the second end 34b of the actuating element 34 is engaged directly with the brake cam 30.

The first end 34a and the second end 34b of the actuating element 34 are received for example in sleeves 84a, 84b. The sleeves 84a, 84b can be pressed or crimped on the actuating element 34, i.e. on the wire consisting of the shape memory alloy 36. Therefore, the wire can be coupled in a simple manner at its first end 34a to the holding structure and at its second end 34b to the slide 38 or to the brake cam 30.

Alternatively, it is also feasible for the first end 34a and the second end 34b of the actuating element 34 to be extrusion-coated, e.g. with an electrically insulating synthetic material, in order to form e.g. a sleeve 84a, 84b. In other words, according to this alternative the sleeves 84a, 84b are injection moulded on the respectively associated first end 34a or second end 34b. However, it is also feasible for the second end 34b to be extrusion-coated with and/or embedded into, the slide 38.

Alternatively or in addition, the first end 36a can be extrusion-coated with and/or embedded into, the holding structure.

The first end 34a and the second end 34b of the actuating element 34 preferably form the electric terminals of the actuating element 34. For example, cables are soldered, crimped or plugged by means of plug contacts directly to the first end 34a and the second end 34b.

In the variant of FIG. 6, the actuator 31 likewise comprises an actuating element 34 comprising a shape memory alloy 36. Specifically, the actuating element 34, as before, is formed as a wire which is produced from the shape memory alloy 36.

The actuating element 34 is fastened at a first end 34a to a fastening element receiver of the holding structure 35 which, in the illustrated example, is formed by the actuator housing 39.

The other end 34b of the actuating element 34 is fastened to a slide 38 which is mounted so as to be movable on the holding structure 35, i.e. on the actuator housing 39, via two elastic bearing elements 74 which in the present case are each designed as leaf spring elements.

As already explained, the two ends 34a, 34b of the actuating element 34 are provided with injection-moulded sleeves 84a, 84b.

In this regard, the slide 38 is substantially L-shaped, wherein the relatively longer limb of the L-shaped slide 38 is oriented in parallel with the actuating element 34.

The two elastic bearing elements 74 are connected to the relatively longer limb.

The relatively shorter limb of the L-shaped slide 38 is oriented substantially at a right angle to the relatively longer limb.

An actuating pin 40 having a pin axis 40a, more precisely an actuating element-side end of the actuating pin 40, is rigidly connected to the relatively shorter limb. The actuating pin 40 points away from the relatively longer limb and extends through a through-going opening which is provided on the holding structure 35, i.e. on the actuator housing 39, and so a free end of the actuating pin 40 lies adjacent to the brake element 29 which in the present case is in the form of a brake cam 30. The brake element-side end 41 of the actuating pin 40 can thus lie on the brake element 29, i.e. on the brake cam 30 or, upon actuation of the actuating element 34 can be placed on the brake element 29, i.e. on the brake cam 30.

There is thus no tensile coupling between the actuating pin 40 and the brake element 29, i.e. the brake cam 30. This means that no tensile forces can be introduced into the brake element 29 by means of the actuating pin. Incidentally, this also applies for the embodiment of FIG. 3.

The free end of the actuating pin 40, i.e. the brake element-side end 41 of the actuating pin 40 is rounded.

The through-going opening, through which the actuating pin 40 extends, is used to guide the actuating pin 40.

Furthermore, in the region of the brake element-side end 41 of the actuating pin 40, a stop ring is fastened, by means of which a movement of the brake element-side end 41 of the actuating pin 40 in the direction of the holding structure 35, i.e. in the direction of the actuator housing 39, is limited.

A central axis of the actuating pin 40, i.e. a pin axis 40a, extend in a parallel-offset manner with respect to the actuating element 34.

If the actuating element 34 is powered with an electric current of sufficient magnitude, heat-induced lattice conversion of the shape memory alloy 36 takes place which results in the actuating element 34 shortening. This results in displacement of the slide 38 and of the actuating pin 40 towards the right in FIG. 6. As a result, the brake cam 30 is brought into engagement with the saw blade 20 and brakes it until it comes to a standstill.

This movement of the slide 38 is limited by virtue of the relatively shorter limb of the slide 38 possibly lying on the holding structure 35, i.e. on the actuator housing 39.

Provided that the actuating element 34 is no longer supplied with a current and accordingly cools down, the previously heat-induced lattice conversion is reversed and the actuating element 34 is elongated back to its initial length.

The slide 38 is always spring-loaded by the elastic bearing elements 74 in a direction corresponding to a tensile loading of the actuating element 34. In this manner, the slide 38 is reliably returned to its starting position.

In summary, in the embodiment according to FIG. 6 the second end 34b of the actuating element 34 is drivingly coupled to the brake element 29, i.e. the brake cam 30, via the slide 38 and the actuating pin 40.

In terms of a compact design, the brake element-side end 41 of the actuating pin 40 is arranged between the first end 34a of the actuating element 34 and the second end 34b of the actuating element 34 in a direction in parallel with the actuating element 34. This is immediately clear from the view of FIG. 6 if a perpendicular line to the actuating element 34 is notionally drawn at each end 34a, 34b, said line intersecting the pin axis 40a. The brake element-side end 41 of the actuating pin 40 is then located between these two points of intersection.

Furthermore, a length L_{BE} of the actuating element 34 in the embodiment according to FIG. 6 is smaller than a dimension A of the emergency brake unit 24 in a direction in parallel with the length L_{BE} of the actuating element 34. Moreover, the length L_{BE} of the actuating element lies completely within a dimension A of the emergency brake unit 24 measured in parallel with the length L_{BE} of the actuating element 34. The dimension A, which can also be referred to as maximum dimension, is formed by a dimension of the brake calliper 26 which is measured in parallel with the actuating element. It is directly apparent from FIG. 6 that the actuating element 34 is shorter than this dimension A. If perpendicular lines extending from top to bottom are drawn in FIG. 6 at the start and end of the dimension A of the brake calliper 26, the actuating element 34 is located between these lines.

FIG. 7 shows a further embodiment which is similar to the embodiment of FIG. 6. Only the differences with respect to the embodiment of FIG. 6 will thus be explained hereinafter, For the remainder, reference can be made to the explanations relating to the embodiment according to FIG. 6.

A first difference between the embodiment according to FIG. 7 and the embodiment according to FIG. 6 resides in the fact that the slide 38 is mounted so as to be movable on the holding structure 35, i.e. on the actuator housing 39, by means of two articulation arms 76.

The articulation arms 76 are intrinsically rigid. However, these are connected via in each case a first pivot joint to the slide 38 and via in each case a second pivot joint to the holding structure 35.

A second difference resides in the fact that a spring element 37 is now once again provided. The spring element 37 is arranged between the relatively shorter limb of the L-shaped slide 38 and a portion, opposite this limb, of the holding structure 35, i.e. of the actuator housing 39.

The slide 38 is thus always spring-loaded by the spring element 37 in a direction corresponding to a tensile loading of the actuating element 34. In this manner, the slide 38 is reliably returned to its starting position, if the actuating element 34 is no longer supplied with a current.

Furthermore, the spring element 37 which is designed as a helical spring, circumferentially surrounds the actuating pin 40.

The spring element 37 and the actuating pin 40 are also arranged coaxially.

A further embodiment of an emergency brake unit 24 is shown in FIGS. 8 and 9. FIG. 8 shows inter alia a brake calliper 26 of the emergency brake unit 24 in a view in a direction located within a saw blade plane of the saw blade 20. The position of the saw blade 20 is indicated with dashed lines.

FIG. 9 shows an associated sectional view in a plane IX-IX.

In the embodiment according to FIGS. 8 and 9, the actuating element 34 and a slide 38, to which the second end 34b of the actuating element 34 is fastened, are arranged on a common carrier plate 78 which is designed for example as a board.

A control circuit 42 which will be explained in further detail hereinafter is also provided on the carrier plate 78. The carrier plate 78 having the control circuit 42 can be referred to as a control unit.

As before, the brake cam 30 can be actuated by means of an actuating pin 40 rigidly attached to the slide 38.

The carrier plate 78 and the actuating element 34 are positioned such that they mechanically shield a drive coupling portion of the brake element 29, i.e. a region of the brake cam 30 which is formed to allow the actuating pin 40 to lie thereon. This is apparent in particular from the view of FIG. 9.

In this view, a human finger or a human hand cannot reach the drive coupling portion from above since access through the carrier plate 78 and the actuating element 34 is blocked. This is also true for foreign bodies, e.g. dust particles.

As already explained in conjunction with the embodiment of FIG. 6, in the embodiment according to FIGS. 8 and 9 a length L_{BE} of the actuating element 34 is smaller than a dimension A of the emergency brake unit 24 in a direction in parallel with the length L_{BE} of the actuating element 34. Moreover, the length L_{BE} of the actuating element 34 lies completely within a dimension A of the emergency brake unit 24 measured in parallel with the length L_{BE} of the actuating element 34.

In all of the previously explained variants, the slide 38 and the actuating pin 40 can be referred to more generally as intermediate elements 80.

Another term for the actuating pin 40 is pushrod.

Furthermore, in the previously described examples a combination of the actuator 31 and brake element 29, i.e. brake cam 30, can be referred to as emergency brake assembly 82. The emergency brake assembly 82 thus represents a sub-unit of the emergency brake unit 24, wherein the emergency brake unit 24, as already explained, is formed to brake the saw blade 20 until it comes to a standstill.

FIG. 10 shows an embodiment of the actuator unit 32 in the form of an electrical circuit diagram.

The actuating element 34 of the actuator 31 is represented by a variable resistance R_{BE}.

The actuator 31, i.e. the actuating element 34, is electrically connected to a control circuit 42 which is formed to selectively supply the actuating element 34 with electrical energy, and so the above-mentioned microstructural conversion is induced.

In this regard, the control circuit 42 comprises an electrical energy storage unit 44 in the form of a capacitor with an adjustable capacitance.

Furthermore, the control circuit 42 has an electrical switching element 45, by means of which the energy storage unit 44 and the actuating element 34 can be selectively electrically coupled. The electrical coupling takes place via an optionally provided resistor 46.

The control circuit 42 also comprises a charging circuit 48 for the energy storage unit 44. This has a direct voltage source 50 which is coupled to the energy storage unit 44 via an adjustable voltage converter 52 and a further electrical switching element 54. An electrical resistance of the charging circuit 48 is given by the resistance R_{LS}.

The electrical switching element 45 and also the further electrical switching element 54 are actuated by means of a trigger control unit 56 which is coupled to the saw blade 20 acting as the sensor element.

The electrical switching element 45 is open in an initial state, i.e. the actuating element 34 is electrically disconnected from the energy storage unit 44. The further switching element 54 is closed, and so the energy storage unit 44 is brought to, or kept at, a desired state of charge by means of the direct voltage source 50.

When the trigger control unit 56 detects actual contact, or a risk of contact, between the user and saw blade 20, the electrical switching element 45 is closed and the further electrical switching element 54 is opened. Therefore, the energy storage unit 44 is electrically connected to the actuating element 34 and so an electric current is fed through the actuating element 34, said current inducing microstructural conversion of the shape memory alloy 36.

In the embodiment of FIG. 10, this can occur in dependence upon a first operating parameter Bl of the actuator 31. In the illustrated exemplified embodiment, this parameter is an electrical resistance or a temperature. Since the actuating element 34 has a characteristic, temperature-dependent electrical resistance, the electrical resistance and the temperature can be converted into each other. The curve of the electrical resistance of the actuating element 34 over temperature can be presupposed to be known.

For this purpose, the control circuit 42 comprises a current measuring unit 58 which measures a current I_{BE} flowing through the actuating element 34, and a voltage measuring unit 60 which measures a voltage U_{BE} dropping across the actuating element.

The current measuring unit 58 and also the voltage measuring unit 60 are coupled by signal technology to a state control unit 62. An electrical resistance of the actuating element 34 can be calculated by means of the state control unit 62 with the aid of the voltage U_{BE} and the current I_{BE}. The temperature of the actuating element 34 can also be determined via the known correlation between the electrical resistance and the temperature.

The state control unit 62 is also coupled by signal technology to the voltage converter 52. Therefore, it is possible to adjust a voltage in dependence upon the resistance or the temperature of the actuating element 34, said voltage being divided between the adjustable resistor 46 and the energy storage unit 44. In other words, a storage voltage of the energy storage unit 44 can be adjusted.

It is understood that current has to flow through the actuating element 34 in order for its electrical resistance and/or its temperature to be able to be determined by means of the current measuring unit 58 and the voltage measuring unit 60. This means that the resistance and/or the temperature can be measured during actuation of the actuating element 34.

Alternatively or in addition, a measuring method can be performed by means of the trigger control unit 56, in which method the actuating element 34 is temporarily supplied with current merely in order to measure the resistance and/or temperature.

The state control unit 62 is also coupled by signal technology to an ambient sensor 63a, by means of which an ambient parameter U can be detected. In the illustrated example, the ambient parameter U is an ambient temperature. The voltage converter 52 and/or the energy storage unit 44 can thus also be operated and/or adjusted in dependence upon the ambient temperature.

In addition, the state control unit 62 is coupled by signal technology to a tool state sensor 63b. This is configured to determine a second operating parameter B2 of the tool 8 equipped with the actuator 31. In the present example, this is a rotational speed sensor which measures a rotational speed of the tool 8. The voltage converter 52 and/or the energy storage unit 44 can thus also be operated and/or adjusted in dependence upon the rotational speed.

FIG. 11 shows an alternative embodiment of the actuator unit 32 in the form of an electrical circuit diagram. Only the differences from the embodiment shown in FIG. 10 will be discussed hereinafter. Identical or mutually corresponding elements are designated by the same reference signs.

Firstly, in the embodiment according to FIG. 11 the energy storage unit 44 can no longer be adjusted but has a constant storage capacitance.

The electrical resistor 46 is then optional.

Furthermore, a heating circuit or temperature-control device 64 is provided.

In this regard, the electrical switching element 45 is modified such that as before, in a first position, it connects the energy storage unit 44 to the actuating element 34 in an electrically conductive manner.

In a second position, the electrical switching element 45 connects the actuating element 34 to the heating circuit or temperature-control device 64, and so a heating current can be fed through the actuating element 34 in order to heat this to a desired temperature.

In the embodiment according to FIG. 11, the state control unit 62 further comprises a heating regulator 66.

The heating regulator 66 uses the current I_{BE} determined by means of the current measuring unit 58 and the voltage U_{BE} determined by means of the voltage measuring unit 60 as input parameters.

The current measuring unit 58 and the voltage measuring unit 60 thus form a measuring instrument of the temperature-control device 64, by means of which a temperature of the actuating element 34 and/or an electrical resistance of the actuating element 34 can be measured.

As already mentioned, an electrical resistance of the actuating element 34 can be calculated therefrom or, using the known correlation between temperature and electrical resistance, a temperature of the actuating element 34.

Therefore, the heating regulator 66 can be operated with a temperature as a reference variable or with an electrical resistance as a reference variable.

In this respect, by means of the heating regulator 66 an additional electrical switching element 68 can be controlled e.g. with a pulse width-modulated signal.

The voltage converter 52 is adjusted as usual.

FIG. 12 shows a further alternative embodiment of the actuator unit 32 in the form of an electrical circuit diagram. Only the differences with respect to the embodiments according to FIGS. 10 and 11 will be discussed hereinafter. Identical or mutually corresponding elements are designated by the same reference signs.

In contrast to the embodiment according to FIG. 11, in the embodiment according to FIG. 12 the voltage converter 52 is no longer adjustable. This means that the voltage converter 52 always sets the voltage of the energy storage unit 44, which in the present case is formed by the energy storage elements 44a, 44b, to a fixed value.

The energy storage unit 44 thus now comprises two energy storage elements 44a, 44b which are each formed as electrical capacitors.

These are electrically connected in parallel.

Furthermore, instead of only one optional electrical resistor 46, two optional electrical resistors 46a, 46b are now provided which are each connected in parallel with each other and in series with one of the energy storage elements 44a, 44b.

The energy storage element 44a and the electrical resistor 46a can be coupled, as usual, to the direct voltage source 50 via the electrical switching element 54.

The energy storage element 44b and the electrical resistor 46b can be selectively coupled by means of an additional electrical switching element 70, i.e. the energy storage element 44b and the electrical resistance 46b are only connected to the direct voltage source 50 when the electrical switching element 54 and also the electrical switching element 70 are closed.

The electrical switching element 70 is connected by means of the state control unit 62.

Therefore, the energy storage element 44b and the electrical resistor 46b can be utilised in dependence upon an electrical resistance and/or temperature of the actuating element 34.

Furthermore, the energy storage element 44b and the electrical resistor 46b can be utilised in dependence upon an ambient parameter U determined by means of the ambient sensor 63a and/or in dependence upon a second operating parameter B2 determined by means of the machine state sensor 63b.

FIG. 13 shows an additional alternative embodiment of the actuator unit 32 in the form of an electrical circuit diagram. Only the differences with respect to the preceding embodiments will be discussed hereinafter. Identical or mutually corresponding elements are designated by the same reference signs.

In contrast to the embodiment according to FIG. 11, in the embodiment according to FIG. 13 the voltage converter 52 is no longer adjustable. This means that the voltage converter 52 always sets the voltage of the energy storage unit 44 to a fixed value.

A further difference resides in the fact that an adjustable electrical resistor 72 is provided in series with the electrical resistor 46. This is adjusted by means of the state control unit 62.

This can be effected, as before, in dependence upon an ambient parameter U determined by means of the ambient sensor 63a and/or in dependence upon a resistance determined by means of the current measuring unit 58 and the voltage measuring unit 60 and/or in dependence upon a temperature determined by means of the current measuring unit 58 and the voltage measuring unit 60 and/or in dependence upon a second operating parameter B2 determined by means of the machine state sensor 63b.

In summary, the embodiments according to FIGS. 10 and 12 are characterised by an energy storage unit 44 with an adjustable capacitance.

The control circuits 42 according to FIGS. 12 and 13 further have an adjustable electrical resistor 46, 46a, 46b, 72.

Moreover, in the case of the control circuits 42 according to FIGS. 10 and 13 the voltage converter 52 is adjustable and so a storage voltage of the energy storage unit 44 can be adjusted.

In all of the control circuits 42, the actuation time of the electrical switching element 45 is also adjustable.

In all of the preceding embodiments, the actuator 31 can be operated by means of a method for operating an actuator of an emergency brake unit.

An ambient parameter U, in this case the ambient temperature, is detected by means of the ambient sensor 63a.

In addition, in all of the preceding embodiments, an electrical resistance and/or temperature of the actuating element 34 is detected by means of the current measuring unit 58 and the voltage measuring unit 60. In short, these can be referred to as first operating parameter B1 of the actuator 31.

Provision is also made in all of the embodiments that a second operating parameter B2 of the tool 8 equipped with the actuator 31 is detected by means of the machine state sensor 63b, in this case the rotational speed.

Based on this, in all of the embodiments the actuator 31 is operated in dependence upon the ambient parameter U, the first operating parameter B1 and the second operating parameter B2. This means that an actuating current parameter SP for the actuating element 34 is adjusted in dependence upon the ambient parameter U, the first operating parameter B1 and the second operating parameter B2.

In the embodiments according to FIGS. 12 and 13, in this respect the electrical resistance applied between the energy storage unit 44 and the actuating element 34 is adjusted in dependence upon the ambient parameter U, the first operating parameter B1 and the second operating parameter B2.

In the embodiments according to FIGS. 10 and 12, for this purpose the capacitance of the energy storage unit 44 is adjusted in dependence upon the ambient parameter U, the first operating parameter B1 and the second operating parameter B2.

Furthermore, in the embodiments according to FIGS. 10 and 11 the storage voltage of the energy storage unit 44 is adjusted via the adjustable voltage converter 52 in dependence upon the ambient parameter U, the first operating parameter B1 and the second operating parameter B2.

Furthermore, in all of the embodiments the actuating current parameter SP is adjusted in that an actuating time of the switching element 54 is adjusted in dependence upon the ambient parameter U, the first operating parameter B1 and the second operating parameter B2.

In addition, in the embodiments according to FIGS. 11, 12 and 13 the temperature of the actuating element 34 can be controlled by means of the temperature-control device 64 to a temperature above a current ambient temperature and below a switching temperature of the actuating element 34.

In the present case, it was stated that the actuating current parameter SP is adjusted in dependence upon the ambient parameter U, the first operating parameter B1 and the second operating parameter B2. However, it is understood that only one or two of these parameters can also be used.

In all of the preceding exemplified embodiments, the emergency brake unit 24 or the emergency brake assembly 82 can be operated as follows.

In a first step, the brake element 29, in the present case the brake cam 30 is moved by means of the actuating element 34. In this respect, the actuating element 34 is shortened by way of a corresponding supply of current. As already mentioned, in the embodiments according to FIGS. 3 and 6 to 9 a compressive force is thereby applied to the brake cam 30 by the actuating pin 40. In the embodiment according to FIG. 4, the second end 34b of the actuating element 34 is fastened directly to the brake cam 30 and applies a tensile force thereto.

As a result, in all of the embodiments the brake cam 30 comes into contact with the saw blade 20. Since in the present case the emergency brake assembly 82 or emergency brake unit 24 is designed in a self-reinforcing manner, the brake cam 30 is entrained by the saw blade 20 owing to the contact. This results in the fact that the brake cam 30 presses the saw blade 20 against the pressure element 28 with an increasing force until the saw blade 20 comes to a standstill.

In this regard, after the initial movement of the brake cam 30 a movement coupling between the actuating element 34 and brake element 29, i.e. brake cam 30, is terminated or cancelled.

In the embodiments according to FIGS. 3 and 6 to 9, this occurs by virtue of the fact that the brake element-side end 41 of the actuating pin 40 is lifted off from the brake element 29, i.e. from the brake cam 30. In the embodiment according to FIG. 4, this occurs by virtue of the fact that the brake cam 30 is moved so far that the actuating element 34 is no longer under mechanical stress and accordingly a tensile force can no longer be introduced into the brake element 29, i.e. the brake cam 30.

This has the result that the actuating element 34 can be returned to an initial position, i.e. to its unactuated position, after being suitably cooled. For this purpose, the heat-induced microstructural conversion is reversed. The returning occurs independently of the brake element 29, i.e. of the brake cam 30, which can be returned separately from the actuating element 34.

The preceding explanations relate to a sawing device 10 in the form of a mitre saw. However, it is understood that the design as a mitre saw is only one example and the preceding statements are also applicable to other types of sawing devices, e.g. belt saws.

### LIST OF REFERENCE SIGNS

8 motor-driven tool
10 sawing device
12 base part
14 support surface
16 workpiece
18 pivot device
18a first portion
18b second portion
20 saw blade
22 handle
24 emergency brake unit
26 brake calliper
28 pressure element
29 brake element
30 brake cam
31 actuator
32 actuator unit
34 actuating element
34a first end
34b second end
35 holding structure
36 shape memory alloy
37 spring element
38 slide
39 actuator housing
40 actuating pin
40a pin axis
41 brake element-side end of the actuating pin
42 control circuit
44 electrical energy storage unit
44a electrical energy storage element
44b electrical energy storage element
45 electrical switching element
46 electrical resistor
46a electrical resistor
46b electrical resistor
48 charging circuit
50 direct voltage source
52 voltage converter
54 further electrical switching element
56 trigger control unit
58 current measuring unit
60 voltage measuring unit
62 state control unit
63a ambient sensor
63b machine state sensor
64 heating circuit, temperature-control device
66 heating regulator
68 electrical switching element
70 electrical switching element
72 electrical resistor
74 elastic bearing element
76 articulation arm
78 carrier plate
80 intermediate element
82 emergency brake assembly
84a first sleeve
84b second sleeve
A dimension
B1 first operating parameter
B2 second operating parameter
I_{BE} current through the actuating element
L_{BE} length of the actuating element
R_{BE} electrical resistance of the actuating element
R_{LS} electrical resistance of the charging circuit
SP actuating current parameter
U ambient parameter
U_{BE} voltage drop across the actuating element

1. An emergency brake assembly for a motor-driven tool, comprising:
a holding structure,
a brake element mounted on the holding structure so as to be movable, and
a wire-shaped actuating element comprising a shape memory alloy,
wherein a first end of the wire-shaped actuating element is fastened to the holding structure and a second end of the wire-shaped actuating element is drivingly coupled to the brake element.

2. The emergency brake assembly as claimed in claim 1, wherein the second end of the wire-shaped actuating element is fastened to the brake element.

3. The emergency brake assembly as claimed in claim 1, wherein the second end of the wire-shaped actuating element is coupled to the brake element via at least one intermediate element.

4. The emergency brake assembly as claimed in claim 3, wherein the at least one intermediate element comprises a slide which is mounted on the holding structure so as to be movable.

5. The emergency brake assembly as claimed in claim 4,
wherein the slide is mounted on the holding structure so as to be movable in translation via a slide guide, and/or
wherein the slide is mounted on the holding structure so as to be movable via at least one articulation arm, and/or
wherein the slide is connected to the holding structure via an elastic bearing element

6.-7. (canceled)

8. The emergency brake assembly as claimed in claim 3, wherein the at least one intermediate element comprises a pushrod or an actuating pin having a brake element-side end, wherein the brake element-side end of the pushrod or actuating pin lies on the brake element or is configured to be placed on the brake element.

9. The emergency brake assembly as claimed in claim 8, wherein the brake element-side end of the pushrod or actuating pin is decoupled from the brake element or is configured to be decoupled from the brake element via tensile forces.

10. The emergency brake assembly as claimed in claim 8, wherein the brake element-side end of the pushrod or actuating pin lies between the first end of the wire-shaped actuating element and the second end of the wire-shaped actuating element in a direction in parallel with the wire-shaped actuating element.

11.-14. (canceled)

15. The emergency brake assembly as claimed in claim 8, any wherein an actuating element-side end of the pushrod or actuating pin is coupled to the slide.

16. The emergency brake assembly as claimed in claim 1 wherein the wire-shaped actuating element is guided by means of a guide element.

17. The emergency brake assembly as claimed in claim 1, further comprising:
a spring element, by which the wire-shaped actuating element is directly or indirectly spring-loaded in a direction corresponding to a tensile loading of the wire-shaped actuating element.

18.-19. (canceled)

20. The emergency brake assembly as claimed in claim 1, wherein the holding structure is formed by an actuator housing and/or a brake caliper.

21. The emergency brake assembly as claimed in claim 20, wherein a control unit for the wire-shaped actuating element is integrated into the actuator housing at least in sections.

22. The emergency brake assembly as claimed in claim 1, wherein a first sleeve is provided on the first end of the wire-shaped actuating element and the first end of the wire-shaped actuating element is fastened to the holding structure via the first sleeve.

23. The emergency brake assembly as claimed in claim 1, wherein a second sleeve on the second end of the wire-shaped actuating element and the second end of the wire-shaped actuating element is drivingly coupled to the brake element via the second sleeve.

24. The emergency brake assembly as claimed in claim 1,
wherein a first sleeve is provided on the first end of the wire-shaped actuating element. the first end of the wire-shaped actuating element is fastened to the holding structure via the first sleeve, and the first sleeve is injection moulded on the wire-shaped actuating element, and/or
wherein a second sleeve on the second end of the wire-shaped actuating element, the second end of the wire-shaped actuating element is drivingly coupled to the brake element via the second sleeve, and the second sleeve is injection moulded on the wire-shaped actuating element.

25. The emergency brake assembly as claimed in claim 1, wherein a length of the wire-shaped actuating element is smaller than a dimension of the emergency brake unit in a direction in parallel with the length of the wire-shaped actuating element and/or wherein a length of the wire-shaped actuating element lies completely within a dimension of the emergency brake unit measured in parallel with the length of the wire-shaped actuating element.

26. The emergency brake assembly as claimed in claim 1, wherein the wire-shaped actuating element and/or a portion of the holding structure mechanically shields a drive coupling portion of the brake element.

27. A method for operating an emergency brake assembly having a movably mounted brake element, for braking a cutting element of a motor-driven tool, wherein the emergency brake assembly further comprises a wire-shaped actuating element comprising a shape memory alloy, and the wire-shaped actuating element is drivingly coupled to the brake element, the method comprising:
moving the brake element with the wire-shaped actuating element, and
subsequently cancelling or terminating a movement coupling between the wire-shaped actuating element and the brake element.

28. The method as claimed in claim 27, further comprising:
returning the wire-shaped actuating element to an initial position,
wherein the returning takes place independently of the brake element.
